(19) United States
(12) Patent Application Publication
(10) Pub. No.: US 2013/0030556 A1
(43) Pub. Date: Jan. 31, 2013

(54) METHODS AND SYSTEMS TO RECOGNIZE QUANTITATIVE MISPRICING OF GAMING MARKERS

(71) Applicants: Karl G. Wolfe, Cherry Hill, NJ (US); Ryan C. Mastro, Galloway, NJ (US)

(72) Inventors: Karl G. Wolfe, Cherry Hill, NJ (US); Ryan C. Mastro, Galloway, NJ (US)

(21) Appl. No.: 13/575,606

(22) PCT Filed: Jan. 28, 2011
(86) PCT No.: PCT/US11/22952

§ 371 Date: Oct. 16, 2012

Related U.S. Application Data
(60) Provisional application No. 61/300,013, filed on Jan. 31, 2010.

(51) Int. Cl. G06F 19/00

(52) U.S. Cl. 700/93

(57) ABSTRACT

Systems and methods for recognizing and evaluating the quantitative mispricing of gaming markers. One method includes the steps of defining at least two entities, defining a measured marker, defining a cumulative period of events of the two entities, each event having the measured marker, assigning a value to the measured marker based on the at least two entities achievement or failure to obtain the measured marker for each event during the cumulative period, measuring the divergence of the value of the measured marker during the cumulative period, and quantifying the divergence. One such system accepts information from a user via an interface, calculates a divergence value and/or graph(s) for upcoming event(s) based upon the information input by the user, and provides the divergence value and/or graph(s) to a user. The divergence value may be compared to a scale of divergence values to evaluate a strength of such value.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS-REFERENCE TO RELATED APPLICATIONS

This application claims the benefit of the U.S. provisional patent application entitled “Methods and Systems to Recognize Quantitative Mispricing of Gaming Markers” having Ser. No. 61/300,013, filed Jan. 31, 2010, which is hereby incorporated by reference in its entirety as if fully set forth herein.

### INCORPORATION-BY-REFERENCE OF MATERIAL SUBMITTED ON A COMPACT DISC

The computer program listing appendix attached hereto is entitled SMFRQMGMComputerProgramListing.txt, was created on Jan. 27, 2011, has a size of 186 KB, and is incorporated herein by reference in its entirety as if fully set forth herein.

### BACKGROUND OF THE INVENTION

Embodiments of the present invention generally relate to systems and methods for recognizing quantitative mispricing of gaming markers. More specifically, the present invention relates to systems and methods for recognizing quantitative mispricing of gaming markers via calculation of a divergence of a gaming marker from its true value.

The fair value of a security is determined as the mid price of the “bid/ask” spread, which value is based on the public's perceived value of the security. In other words, trades only happen when the security offer price (i.e., the price at which the owner is willing to sell the security) is equal to the bid price (i.e., the price at which a buyer is willing to buy the security). This enables the “market maker” (e.g., a stock broker) to profit on a risk free basis. It should be noted that the reason for a market maker's existence is to supply liquidity to the market. That is, the market maker functions to increase the probability that buy and sell orders from the public are executed. Since the market maker does not want to be exposed to directional risk, the market maker allows increased buying pressure to increase the security price so that there will be more motivation for sellers to sell and vice versa. During this activity, the market maker is making money without risk because there is an equal number of buyers and sellers. In short, prices are established based upon a buyer's perception of the value of the securities and not what they are worth based on a fundamental analysis.

The gaming oddsmaker is in the same position as the market maker; he simply lives in a different environment. Point spreads, odds, and expected point totals are similar to the prices of a stock or other security in that they are established initially by the oddsmaker/market maker. They then dynamically adjust relative to supply and demand and the public's perception of the value of these items in order to ensure equal action on both sides of the wager, which results in a risk free profit for the oddsmaker/market maker.

Based on this understanding, it is necessary to appreciate the theory of “Mean Reversion” and relative overbought/oversold mean conditions and to recognize how these two concepts relate to the quantitative mispricing that results from the improper perception of gaming marker values which is predicated by the psychology of the gaming public.

Means Reversion is a theory suggesting that prices and returns eventually move back towards the mean or average. This mean or average can be the historical average of the price or return or another relevant average such as the average return of an industry or stock. The related concept of Overbought Mean is a situation in which the demand for a certain asset unjustifiably pushes the price of an underlying asset to levels that are far above its true value. This is generally interpreted as a sign that the price of the asset is becoming overvalued and may experience a pullback in price. Similarly, the concept of an Oversold Mean is a situation in which the price of an underlying asset has fallen sharply to a level below that at which its true value resides. This condition is usually a result of market overreaction or panic selling. This is generally interpreted as a sign that the price of the asset is becoming undervalued, and it may represent a buying opportunity for investors.

This “range determined price movement” is ongoing in stocks, currencies, metals, commodities, and gaming. Market psychology is ever-present in the sports book industry, and it leads to short term mispricing in matchups in which one side is significantly overbought (overvalued) and the other side is significantly oversold (undervalued).

The odds makers know when the public will have an overvalued view or an undervalued view of any particular team (or other wagering choice) and will adjust the gaming marker accordingly. The more overvalued a team is based on the perception of the public, the greater the chance for Mean Reversion (e.g., that one may profit by “selling” the team at that “price”) and vice versa.

### BRIEF SUMMARY OF THE INVENTION

Briefly stated, in one aspect of the invention, a method to evaluate defined markers is provided. This method includes: defining at least two entities; defining a measured marker; defining a cumulative period of events of the two entities, each event having the measured marker; assigning a value to the measured marker based on the at least two entities achievement or failure to obtain the measured marker for each event during the cumulative period; measuring the divergence of the value of the measured marker during the cumulative period; and quantifying the divergence.

In another aspect of the present invention, a system employed in connection with providing data to quantify mispricing of a gaming marker to a user, the system for providing the data in an electronic form to a requestor, is provided. The system includes: an interface that allows the requestor to enter information to obtain the data quantifying mispricing of the gaming marker for at least one upcoming event, the information defining at least two entities, a measured marker; and a cumulative period of events of the two entities, each event having the measured marker; a database that receives historical data of historical events; a processing unit to receive the information input by the requestor and perform at least one of the group consisting of calculating a divergence of the at least one upcoming event based upon the information received from the requestor and the historical data; creating at least one graph of historical data, and combinations thereof, the calculating of the divergence including assigning a value to the measured marker based on the at least two entities achievement or failure to obtain the measured marker during the cumulative period; and a display unit to display at least one of the group consisting of the divergence of the at least one upcoming event, the at least one graph, and combinations thereof, to the requestor.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a flow chart of the steps of a method for quantifying the divergence of a marker from its true value in accordance with one embodiment of the present invention;

FIG. 2 is a block diagram of an exemplary computing environment within which various embodiments of the present invention may be implemented;

FIG. 3 depicts a flowchart of the steps of a process for automatically calculating and displaying a divergence for a defined pair of entities, a measured marker, and a cumulative period of events in accordance with one embodiment of the present invention;

FIG. 4 depicts a Web page for receipt of information from a user of the method of FIG. 3;

FIG. 5 depicts a Web page for display of divergence information to a user including a graph of values assigned to a measured marker for a cumulative time period;

FIG. 6 depicts a cumulative game win/loss graph in accordance with an alternate embodiment of the present invention;

FIG. 7 depicts a Web page for display of over/under divergence information to a user including a graph of assigned over/under values assigned to a measured marker for a cumulative time period;

FIG. 8 depicts a cumulative over/under graph in accordance with an alternate embodiment of the present invention;

FIG. 9 depicts a graph of actual over/under values in accordance with an alternate embodiment of the present invention; and

FIG. 10 depicts a graph of divergence significance for upcoming events in a particular sport.

### DETAILED DESCRIPTION OF THE INVENTION

Certain terminology may be used in the following description for convenience only and is not limiting. Where a term is provided in the singular, the inventors also contemplate aspects of the invention described by the plural of that term. As used in this specification and in the appended claims, the singular forms “a”, “an” and “the” include plural references unless the context clearly dictates otherwise, e.g., “a marker” may include a plurality of markers. Thus, for example, a reference to “a method” includes one or more methods, and/or steps of the type described herein and/or which will become apparent to those persons skilled in the art upon reading this disclosure.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods, constructs and materials are now described. All publications mentioned herein are incorporated herein by reference in their entirety. Where there are discrepancies in terms and definitions used in references that are incorporated by reference, the terms used in this application shall have the definitions given herein.

Definitions

Mean Reversion: A theory suggesting that prices and returns eventually move back towards the mean or average. This mean or average can be the historical average of the price or return or another relevant average such as the average return of an industry or stock.

Overbought Mean: A situation in which the demand for a certain asset unjustifiably pushes the price of an underlying asset to levels that are far above its true value. This is generally interpreted as a sign that the price of the asset is becoming overvalued and may experience a pullback in price.

Oversold Mean: A condition in which the price of an underlying asset has fallen sharply to a level below which its true value resides. This condition is usually a result of market overreaction or panic selling. This is generally interpreted as a sign that the price of the asset is becoming undervalued and it may represent a buying opportunity for investors.

Fundamental Analysis: The study of true economic factors and the effect that these factors will have on the value or price of a particular financial instrument (e.g. interest rates, projected market share of a company, oil prices, quarterly earnings reports, projected expenses, etc.). This type of analysis can easily be projected into the marketplace of sports wagering to include individual player matchups, strength of schedule, defensive ranks, offensive ranks, home field or home court advantage, injuries, weather, etc.

Over/Under: The total number of points an oddsmaker expects to be scored in a contest by both teams including overtime points.

Point Spread: The number of points by which an oddsmaker expects a favorite to defeat an underdog.

Push: A tied wager in which the wager is neither won nor lost.

Technical Analysis: The mode of analysis that traders use to predict future market activity based on past price and volume data. The trader that uses technical analysis uses various charts and algorithms to determine the most likely scenarios for trend reversal using price correlations, price cycles, trading activity of the crowd, and, most importantly, pattern recognition tools.

Certain terminology is used herein for convenience only and is not to be taken as a limitation on the present invention. The terminology includes the words specifically mentioned, derivatives thereof and words of similar import. The embodiments discussed herein are not intended to be exhaustive or to limit the invention to the precise form disclosed. These embodiments are chosen and described to best explain the principle of the invention and its application and practical use and to enable others skilled in the art to best utilize the invention.

As noted above, the present invention relates to systems and methods for determining and evaluating the quantitative mispricing of gaming markers which can be used in a variety of analysis situations. The method of the present invention analyzes the value of a marker to determine when it is skewed from its actual value due to, for example, the effects of buying and selling and/or a plurality of tangible and intangible issues having little or nothing to do with a fundamental analysis of the true value of the marker. Specifically, the present invention offers technical analysis in the marketplace of sports gaming by quantifying qualitative data to give knowledgeable traders and speculators information to help identify profit-inducing short-term trend reversals. Based upon the concept of Mean Reversion, the main idea of the present invention is to capture when the expectation of a defined entity (e.g., a team, horse, etc.) is too high or too low. When it is too high, it is likely that the defined entity is experiencing an overbought mean. Conversely, when it is too low, it is likely that the defined entity is experiencing an oversold mean. The theory of Mean Reversion assumes that prices and returns will eventually move back toward the mean or average.

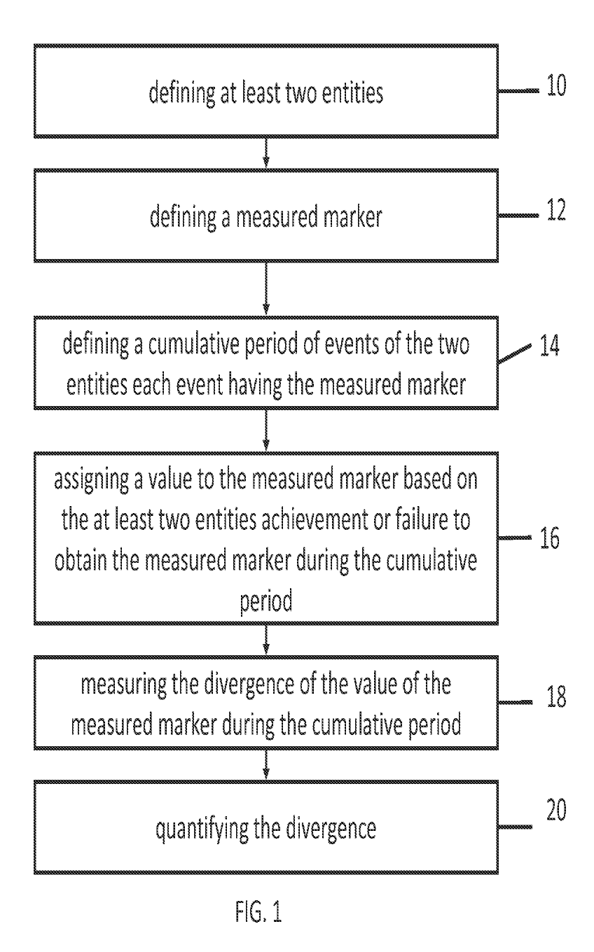

Referring now to FIG. 1, depicted is a method for evaluating defined markers in accordance with one embodiment of the present invention. First, the method defines at least two entities at step 10. The defined entities could be, for example, any head-to-head competitors in an upcoming event including, without limitation, sports teams, horses, etc.

Next, at step 12, at least one measured marker is defined. The measured marker could be any one of a variety of aspects of the upcoming event which may be applied to both entities. For example, the marker could be a point spread in a football game or a Beyer's number (i.e., a number assigned to a horse that quantifies the horse's past performance) in a horse race.

At step 14, a cumulative period of events of the two entities, each event having the measured marker, is defined. The cumulative period is the period of time over which the defined markers will be evaluated for the defined entities. For example, if the defined entities are football teams, the cumulative period of events may be the past five games played by the football teams.

Next, at step 16, the method assigns a value to the measured marker based upon the ability of each of the at least two entities to achieve (or fail to achieve) the measured marker during the cumulative period defined in step 14. The assigned value is based upon a predefined number which represents equal deviations from a value of zero. In this embodiment, an integer value is assigned to the marker for each event occurring during the cumulative period, and the integer value is based upon the ability of each of the at least two entities to achieve (or fail to achieve) the marker for the respective event. The sum of the integer values assigned to the marker(s) may be used to define the divergence spread. Most commonly, the integer value is −1, 0, or +1 for each event. However, more complex values such as those calculated by an algorithm, may be substituted without departing from the scope of the present invention.

For example, in an embodiment of the present invention in which the defined marker is whether a football team will beat the point spread, for each event in which a football team beats the point spread, the event is assigned a positive number such as +1. In contrast, for each event in which the team does not beat (or cover) the point spread, the event is assigned a negative number such as −1. In this manner, each event played by the entity during the defined cumulative period is assigned a value. This same method may be used to assign values to any marker for the events occurring during a given period of time, thereby allowing the method of the present invention to be utilized for markers other than beating a point spread of a football game.

Additionally, in some embodiments of the present invention, the value assigned to the measured marker may be weighted to denote greater significance to an event. For example, the values assigned to the measured marker may be weighted based upon chronological order to allow the most recent events in the defined cumulative period to have a higher significance than events occurring farther back in time.

The method continues at step 18 by measuring the divergence spread of the value of the measured marker during the cumulative period 18. Divergence spread may be measured via one or more calculations involving the values assigned to the measured markers in step 16 as discussed in greater detail below with regards to specific examples of the present invention. Divergence spread may be measured for a single entity. Alternatively, divergence spread may be measured for two entities, which allows the divergence spread of the two entities to be compared or manipulated as discussed herein to determine one entity's future ability to achieve (or fail to achieve) a particular marker in a competition against the second entity.

Thereafter, at step 20, divergence may be quantified based upon a selected number of events occurring during the cumulative period. First, the divergence spread measured in step 18 is divided by a divergence strength number (“DSN”)(i.e., the number of events occurring during the cumulative period that the user decides to include in his or her assessment of the strength of the team). The DSN will vary at the discretion of the user. For example, if the divergence over a five game period is 8, then 8 would be divided by 5 to determine a calculated quantitative value of 1.6 based upon a team's performance in its last five games.

In some embodiments of the present invention, the calculated quantitative value may then be compared to a scale of quantitative values to determine the significance of the quantitative value of the marker. In some embodiments, the significance of the quantitative value will alert a user as to the likelihood that the defined marker may or may not be met in the next competition, or event, due to the theory of Mean Reversion.

In an additional optional step of the present invention, the method of FIG. 1 may be utilized to alert a user if an estimated marker of an upcoming event (e.g., a point spread for an upcoming football game) generates a calculated quantitative value that is determined to be statistically significant (i.e., the value indicates that the likelihood of mispricing of the marker is high). In such an embodiment of the present invention, the quantitative values of one or more markers are calculated for a variety of upcoming sporting events. An algorithm then compares the calculated quantitative value to one or more predefined thresholds (such thresholds may be derived from a scale or customized by a user) to determine which values are considered to be statistically significant (i.e., it is likely that the marker has been mispriced). Scales of statistical significance may be developed based upon theories of relative strength indicators (“RSI”) as appreciated by those skilled in the art.

Any one or more of the quantitative values determined to be statistically significant may then be alerted to a user of the present invention. For example, the method of the present invention may be offered as a service to multiple clients who define entities of interest. When a quantitative value for the client's entity of interest is determined to be statistically significant, the service provider, or the service provider's system, may then alert the client to the quantitative value to allow the client to use the information as a tool to predict an entity's ability to achieve, or fail to achieve, the specified marker in the entity's next competition. In this manner, the present invention identifies and analyzes fundamentals (e.g. factors which affect value) via a technical analysis that assists a user to estimate the future values of particular markers.

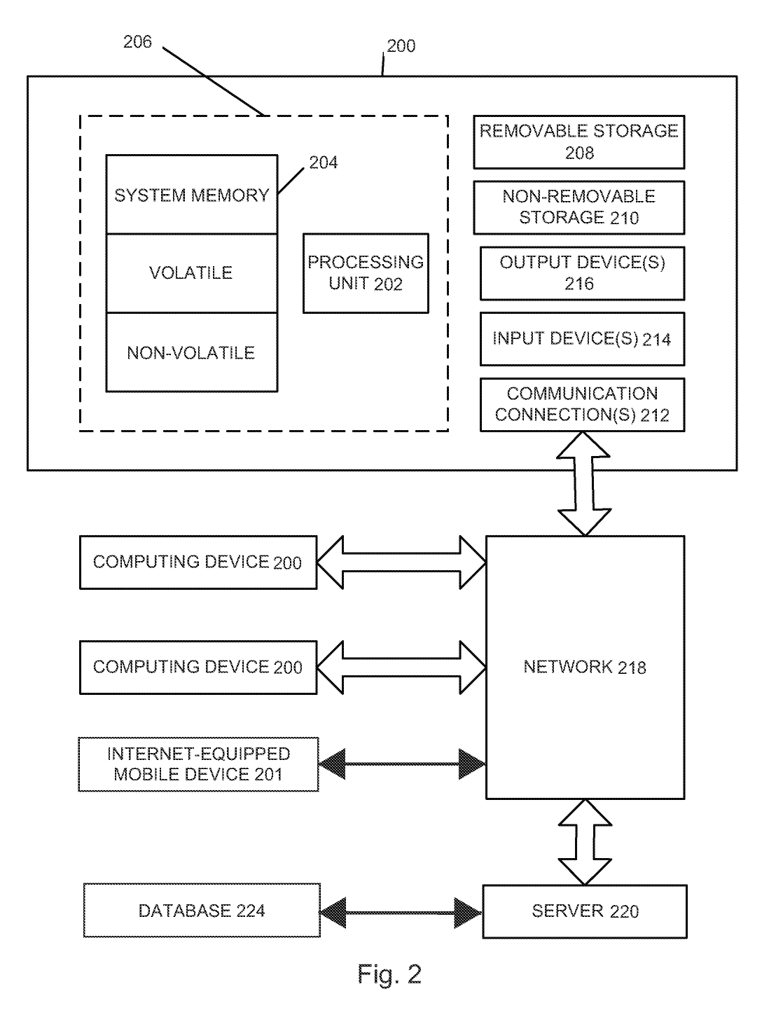

Referring now to FIG. 2, depicted is an exemplary system 250 for implementing embodiments of the present invention. This exemplary system includes, inter alia, a computing device, such as computing device 200. In its most basic configuration, computing device 200 typically includes at least one processing unit 202 and memory 204. Depending on the exact configuration and type of computing device, memory 204 may be volatile (such as random access memory (RAM)), non-volatile (such as read-only memory (ROM), flash memory, etc.), or some combination of the two. This most basic configuration is illustrated in FIG. 2 by dashed line 206. Computing device 200 may have additional features/functionality. For example, computing device 200 may include additional storage (removable and/or non-removable) including, but not limited to, magnetic or optical disks or tape, thumbdrives, and external hard drives. Such additional storage is illustrated in FIG. 2 by removable storage 208 and non-removable storage 210.

Computing device 200 typically includes or is provided with a variety of computer-readable media. Computer-readable media can be any available media that can be accessed by computing device 200 and includes both volatile and non-volatile media, removable and non-removable media. By way of example, and not limitation, computer-readable media may comprise computer storage media and communication media.

Computer storage media includes volatile and non-volatile, removable and non-removable media implemented in any method or technology for storage of information such as computer-readable instructions, data structures, program modules or other data. Memory 204, removable storage 208, and non-removable storage 210 are all examples of computer storage media. Computer storage media includes, but is not limited to, RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 200. Any such computer storage media may be part of computing device 200.

Computing device 200 may also contain communications connection(s) 212 that allow the device to communicate with other devices. Each such communications connection 212 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (“RF”), infrared and other wireless media. The term computer-readable media as used herein includes both storage media and communication media.

Computing device 200 may also have input device(s) 214 such as keyboard, mouse, pen, voice input device, touch input device, etc. Output device(s) 216 such as a display, speakers, printer, etc. may also be included. All these devices are generally known to the relevant public and therefore need not be discussed in any detail herein except as provided.

Notably, computing device 200 may be one of a plurality of computing devices 200 inter-connected by a network 218. Internet-equipped mobile device 201 may be one of a plurality of mobile devices 201 capable of being interconnected to one or more computing devices 200 and/or server 220 by a network 218. As may be appreciated, the network 218 may be any appropriate network, each computing device 200 and/or Internet-equipped mobile device 201 may be connected thereto by way of a connection 212 in any appropriate manner, and each computing device 200 and/or Internet-equipped mobile device 201 may communicate with one or more of the other computing devices 200 and/or Internet-equipped mobile device 201 in the network 218 in any appropriate manner. For example, the network 218 may be a wired or wireless network within an organization or home or the like, and may include a direct or indirect coupling to an external network such as the Internet or the like. Likewise, the network 218 may be such an external network. Computing device 200 and/or Internet-equipped mobile device 201 may connect to a server 220 on the Internet via such an external network.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions, scripts, and the like) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter.

In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application-program interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language, and combined with hardware implementations.

Although exemplary embodiments may refer to utilizing aspects of the presently disclosed subject matter in the context of one or more stand-alone computer systems, the subject matter is not so limited, but rather may be implemented in connection with any computing environment, such as a network 218 or a distributed computing environment. Still further, aspects of the presently disclosed subject matter may be implemented in or across a plurality of processing chips or devices, and storage may similarly be effected across a plurality of devices in a network 218. Such devices might include personal computers, network servers, and handheld devices, for example.

In the exemplary system 250, server 420 includes a database 224. In the exemplary embodiment of the present invention depicted in FIG. 2, database 224 is a structured query language (“SQL”) database with a relational database management system, namely, MySQL as is commonly known and used in the art. However, other databases may be substituted without departing from the scope of the present invention including, but not limited to, PostgreSQL and Oracle databases.

The invention will now be described by way of the following examples which are not to be interpreted as limiting in any manner.

### EXAMPLE 1

Systems and methods of the present invention may be applied to sporting event competitions for various markers. One such marker may be game win/loss (i.e., whether the expected favorite will win an upcoming sporting event).

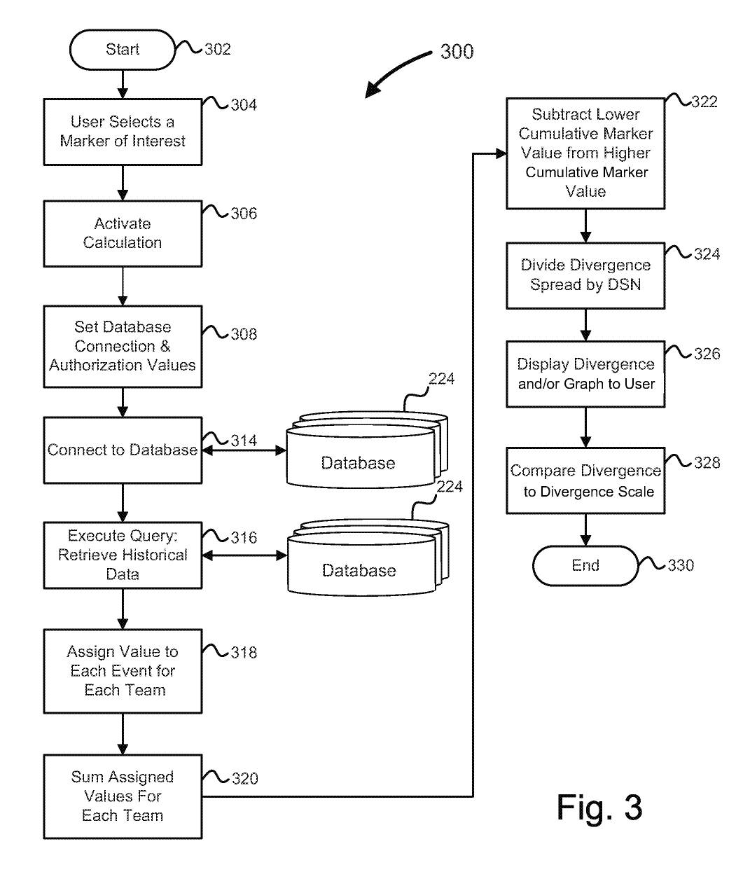

Referring now to FIG. 3, depicted is a method for automatically displaying a quantification of a divergence to a user in accordance with one embodiment of the present invention. Process 300 begins at 302, at which a user wishes to view a quantification of a divergence for an upcoming sporting event in which they are interested. In one exemplary Internet embodiment of the present invention, a user begins this process by accessing a web page on the Internet via a Uniform Resource Locator (“URL”) such as http://www.sportsactioncharts.com. The Web page is accessed by entering the URL into a Web browser program executed by a computing device such as computing device 200. The Web browser program may be any such commonly known program including, but not limited to, Microsoft's Internet Explorer® and Mozilla's Firefox®. The URL is the address of a resource located on the Internet that consists of a communications protocol followed by the name or address of a computer on the network. The URL may also include additional locating information such as directory, file name, and the like. In our exemplary embodiment, the entering of the URL http://www.sportsactioncharts.com at a computing device 200 connects computing device 200 through a network 218 (in our example, network 218 is the Internet) to a computer (i.e., in this example, server 220) having an address of http://www.sportsactioncharts.com. This connection allows server 220 to provide Web pages and Web page content via Internet 218 to a user of method 300 via the Web browser located on his or her computing device 200. Process 300 then proceeds to 304. Although network 218 is the Internet in this exemplary embodiment of the present invention, networks other than the Internet (e.g., a Local Area Lan, Intranet, etc.) may be substituted without departing from the scope of the present invention.

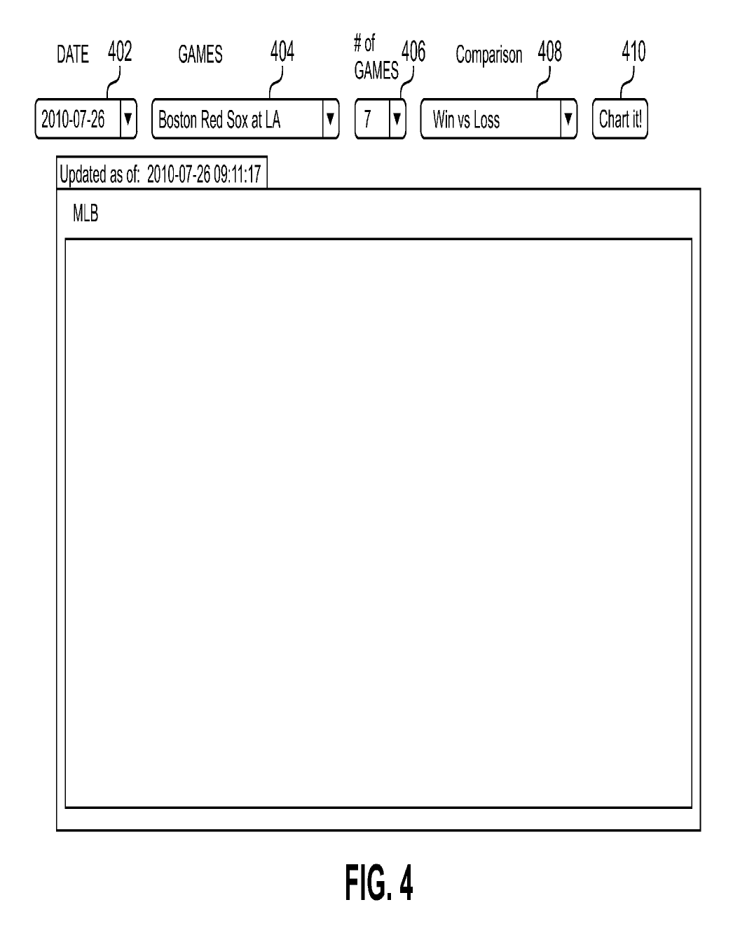

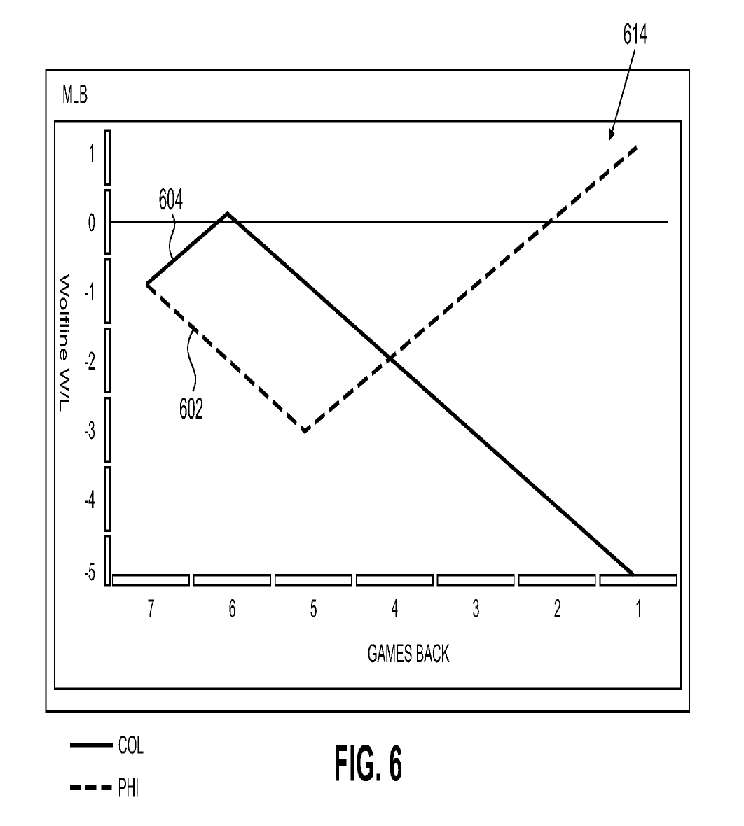

Next, at 304, server 220 provides the user's Web browser with a Web page depicting various upcoming sporting events for which the divergence of gaming markers may be quantified such as the Web page depicted in FIG. 4. This Web page allows a user to select various information regarding the divergence to be quantified via a plurality of pull-down menus including, without limitation: date of the sporting event (pull-down menu 402); competitors in sporting event (pull-down menu 404); the number of historical (already played) events a user wishes to include in his or her assessment of the gaming marker for the next event (pull-down menu 406); and gaming marker to be analyzed and form of gaming marker graph (pull-down menu 408). In the depicted Web page, a user has selected pull-down choices in order to quantify the divergence of a gaming marker for the July 26, 2010 baseball game between the Boston Red Sox and the Los Angeles Angels. The user has also requested use of data for the last seven games played by both teams in the calculation of the divergence by selecting a number of 7 in pull-down menu 406. Selecting win/loss in pull-down menu 408 notifies the system that the gaming marker selected by the user is game win/loss (i.e., which team will win or lose the game) and the user wishes to see a graph of game win/loss in which the actual win or loss for each event is the data value. An alternate graph option that may also be selected via pull-down menu 408 is a “Cumulative Game Win/Loss” option as discussed in greater detail below with respect to FIG. 6.

Next, process 300 proceeds to 306, at which the user has entered all selections in the available pull-down menus. The user then clicks on the chart-it link 410 to activate the system to generate a graph of game win/losses and to calculate a divergence value in accordance with the data entered by the user.

Next, at step 308, the database connection and authorization values are set to allow server 220 to establish a connection to database 224 to allow historical data for game win or loss for the last seven events (as selected by the user)(or, alternatively, previously assigned data values as discussed in greater detail below) for each of the two selected entities to be retrieved therefrom. This historical data is required to calculate the divergence of the upcoming event. It should be noted that although the historical information in our example relates to game win/loss, other types of data may be stored and/or analyzed including, but not limited to, point spread, point spread win/loss, over/under, over/under win/loss and the like.

Database 224 may be automatically or manually programmed with information prior to execution of a method such as method 300, and it may be automatically updated on a periodic basis (e.g., after each event, daily, weekly, etc.) to ensure that it contains the most up-to-date information. Or such information may be updated upon the request of a user. In one embodiment of the present invention, data is updated automatically via methods including, but not limited to, third party data feeds (e.g., Extensible Markup Language (“XML”) data feeds) and pulling data from third party databases via PHP Hypertext Preprocessor (“PHP”) Simple Object Access Protocol (“SOAP”) scripts, Application Programming Interface (“API”) scripts, or the like. Server 220 may pull this information in this manner from any one or more of a variety of commercial information sources associated with gaming through an Internet connection or the like. In such an embodiment, network 218 is the Internet and the commercial information sources are typically available via a computing device connected thereto in the same manner as server 220 and/or computing devices 200.

Alternatively, information in database 224 may be manually updated. In one embodiment of the present invention, a data entry team manually updates database 224 with information gathered from other sources (e.g., newspapers, television, the Internet, etc.). However, alternate methods of updating the data in database 224 may be substituted without departing from the scope of the present invention.

After the database connection and authorization values are set in step 308, process 300 proceeds to 314, at which a bi-directional database connection is established. This connection allows server 220 to communicate with database 224 to retrieve the required historical data. Process 300 then proceeds to 316.

At 316, process 300 will retrieve the data required to assign a value to the measured marker for each event in the selected cumulative time period of seven games back (or, if a value has previously been assigned, the assigned value may be retrieved as discussed in greater detail below). Since the marker selected by the user is game win/loss, server 220 executes a game win/loss value query for each of the selected teams for each of the last seven games played. Once this data is retrieved, the process then proceeds to step 318.

At 318, a value is assigned to each event for each team for the last seven games played. In this embodiment, a value of +1 is applied for each game win and a value of −1 is applied for each game loss. In some embodiments of the present invention, the assigned value is stored in database 224 in relation to the historical game win/loss information to avoid the need to re-assign the value the next time the same historical game win/loss information is required. That is, on a second iteration of step 318, if a value has previously been assigned, the previously assigned value is simply retrieved (the value is not re-assigned).

Next, at 320, for each team, all of the values for each of the last seven games are summed to create a cumulative game win/loss value. At 322, the cumulative game win/loss values are compared and the lower cumulative win/loss value is subtracted from the higher cumulative win/loss value to calculate a divergence spread. In the depicted embodiment of the present invention, data will not be calculated if any of the required data values are not available. For example, if a user has requested a divergence value calculated for seven games back and one (or both) of the teams has not played seven games, the divergence value will be returned to the user as NULL. However, alternate embodiments of the present invention are envisioned in which dummy data or estimates may be substituted for missing data values.

Next, at 324, the divergence spread is divided by the DSN, the latter of which is simply the number of games back for which data shall be analyzed. That is, the DSN is the number of past games the user decides to include in his or her assessment of the strength of the team, and it will vary at the discretion of the user. In our example, the DSN equals 7. The result of this calculation is the divergence value.

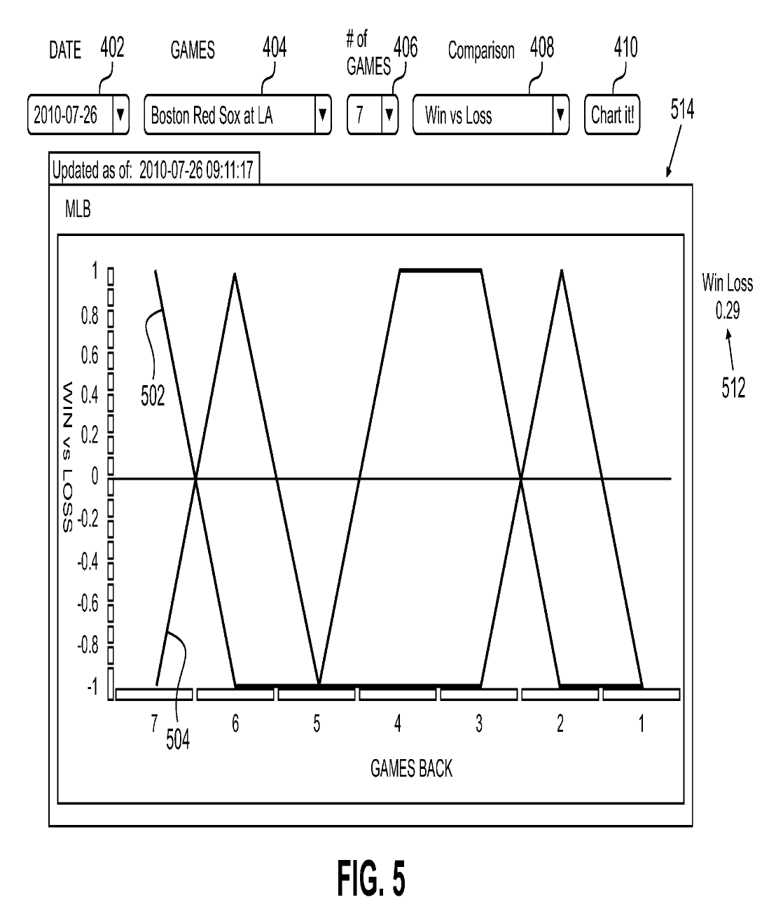

After the divergence value has been calculated, process 300 proceeds to 326 at which it is displayed to a user via a Web page such as that depicted in FIG. 5. Please note that the Web pages of FIGS. 4 and 5 are nearly identical with the exception that the Web page in FIG. 5 includes the game win/loss divergence number 512 and a graph 514 depicting the performance of both teams in the last seven games. In this example, the chart in FIG. 5 shows the win or loss of each game in accordance with the values assigned to each win or loss in step 318 as discussed above (i.e., each win is depicted as a +1 and each loss is depicted as a −1).

In an alternate embodiment of graph 514 created for a user, the graph depicts cumulative game win/loss rather than per event game loss. Such a graph 614 is depicted in FIG. 6 and it may be substituted for graph 514, or provided in addition to graph 514. In one embodiment of the present invention, a user simply selects a “Cumulative Game Win/Loss” option from pull-down menu 408 as discussed in greater detail above.

As seen in FIG. 6, the game win/loss line for each event is cumulative. For example, when reviewing data line 602 for Philadelphia (“PHI”), graph 614 indicates that PHI lost the seventh game back since it is charted as a −1. Graph 614 further indicates that PHI lost the 5^{th} and 6^{th} games back as well since the data line is decremented by 1 for each loss. This results in a cumulative game win/loss value of −3 at five games back. Data line 602 then indicates that PHI wins the following four games as the data line is incremented by +1 for each game resulting in a cumulative game win/loss value of +1 at one game back.

Similarly, the data line 604 for Colorado (“COL”) indicates that COL lost the seventh game back since it is charted as a −1. b Graph 614 further indicates that COL won the 6^{th} game back since the data line is incremented by 1 at this point on the y axis. This results in a cumulative game win/loss value of 0 at six games back. Data line 604 then indicates that COL loses all of the following five games as the data line is decremented by 1 for each game resulting in a cumulative game win/loss value of −5 at one game back.

A cumulative game win/loss graph may be preferred by a user of the method. Also, when calculating divergence, the cumulative game win/loss graph eliminates the need to sum the values assigned to each event since the graph performs this function. Each sum for all events in the cumulative time period is simply equal to the value of one game back (as presented on the cumulative game win/loss graph).

Referring back to FIG. 5, the calculated divergence 512 is depicted as 0.29. This value is derived as discussed above by summing each of the values assigned to the game win/loss of each event for each team. Therefore, the sum of the game win/loss for the Boston Red Sox equals the sum of the data points plotted on data line 502, or +1, −1, −1, −1, −1, +1, and −1 (i.e., the assigned values for seven games back through one game back, respectively), for a total of −3. The sum of the game win/loss for the Los Angeles Angels equals the sum of the data points plotted on data line 504, or 1, +1, −1, +1, +1, −1, and −1 (i.e., the assigned values for seven games back through one game back, respectively), for a total of −1. The divergence spread is calculated by subtracting the lower value of −3 from the higher value of −1 for a total of 2. The divergence spread of 2 is divided by the DSN of 7 (as selected by the user) to equal a divergence of 0.2857, which is rounded up to 0.29.

Finally, at step 328, the calculated divergence may be compared to a scale for such divergence to determine whether the calculated divergence is statistically significant. One such scale follows below in Table 1:

TABLE 1

| Range | Significance | Color Coding |
|---|---|---|
| 0-0.79 | Not Significant | No Color |
| 0.8-1.19 | Significant | Yellow |
| 1.20-1.59 | Very Significant | Orange |
| 1.60-2.00 | Extremely Significant | Red |

The higher the statistical significance of the calculated divergence of the measured marker, the higher the likelihood that Means Reversion will cause an entity to fail to achieve an expected marker. In our example, the divergence value of 0.29 rates a Not Significant in the scale of Table 1. Therefore, it is not likely that Means Reversion will cause an unexpected result in the upcoming competition between Boston and Los Angeles.

In one embodiment of the present invention, the system or method alerts a user when the divergence of a specific measured marker falls within a pre-determined range (e.g., Very Significant or Extremely Significant) as determined by the scale of Table 1.

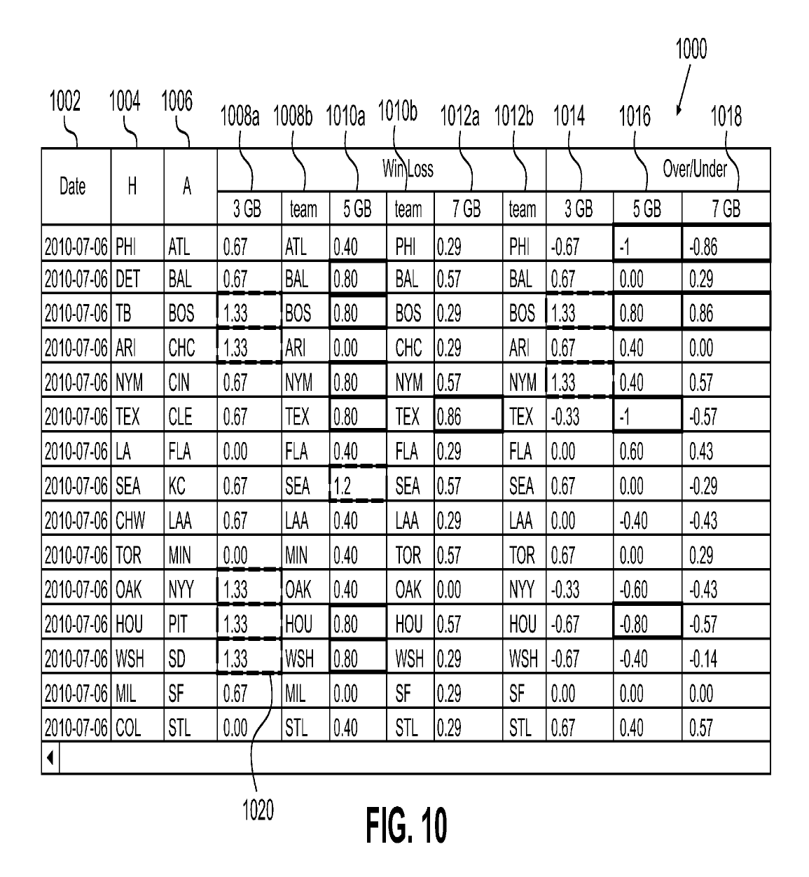

In one embodiment of the present invention, a user is alerted to the significance of all upcoming competitions in a particular sport by selecting “Alert” in the pull-down menu 408. This selection generates a Web page such as that depicted in FIG. 10. FIG. 10 displays a grid 1000 having columns 1002 through 1018 as the grid proceeds from left to right.

Column 1002 depicts the date of an upcoming sporting event. The sporting events depicted in grid 1000 are Major League Baseball sporting events, but divergence may be analyzed and/or alert grids may be created for any type of competition including, but not limited to, those for the National Football League, NCAA Football, the National Basketball Association, NCAA Basketball, and the National Hockey League. Columns 1004 and 1006 list the home and away competitors for each game, respectively.

Columns 1008 through 1012 display the calculated game win/loss divergence for each upcoming competition using historical data for three, five, and seven games back depicted in dedicated columns 1008a, 1010a, and 1012a, respectively. Divergence is calculated as discussed above. Each divergence value has an associated team listed to its right in columns 1008b, 1010b, and 1012b, respectively. The listed team is the one that is being estimated as oversold or underpriced.

Similarly, columns 1014, 1016, and 1018 list the over/under divergence values (which may be calculated as discussed below in Example 2) for three, five, and seven games back, respectively. Importantly, each divergence value is compared to the scales of Table 1 (above) and/or Table 2 (below), and the background of the cell in which the data is contained is colored in accordance with the respective table. For example, if a divergence value falls in a range that is “Not Significant”, the cell background will have no color. Conversely, if a divergence value falls in a range that is “Extremely Significant”, the cell background will be red. Exemplary cell 1020 depicts a cell having a colored background. This allows a viewer of the grid to quickly and easily determine divergence values with high significance as these values indicate the likelihood of an unexpected result due to Means Reversion. Although grid 1000 depicts values for three, five, and seven games back, values may be calculated for any number of games back.

In another embodiment of the present invention, server 220 is programmed to automatically alert a user when a divergence value of interest falls into a particular category. For example, a user may request automatic notification if a game involving the New York Yankees has a divergence that is extremely significant. In this scenario, if divergence falls within the range of 1.6 to 2.0, an alert may be automatically sent to the user from server 220 through a network such as the Internet to, for example, the user's computer, cell phone, or other mobile device (e.g., an Internet-enabled mobile device 201 as discussed above).

As discussed herein, the basic premise behind the present invention is that the oddsmaker will set odds that always try to achieve a 50-50 probability. Public perception and/or wagering are likely to cause a measured marker estimated by an oddsmaker to diverge from a value that would result from a true fundamental analysis. In a situation in which Team B is the underdog and Team A is the favored team expected to beat the point spread, if Team A has historically beat the point spread several times while Team B has not historically beat the point spread, Means Reversion would expect that Team A will not score enough points to beat the point spread in its upcoming competition. The likelihood that Means Reversion will cause an unexpected result is indicated by the significance of the divergence as per the scale of Table 1. In other words, the categories of statistical significance assist a user placing a wager in determining the likelihood of the occurrence of Means Reversion in the upcoming competition in order to allow the user to place his or her wager accordingly.

### EXAMPLE 2

Similar to Example 1, Example 2 is also an application of the systems and methods of the present invention to sporting event competitions for various markers. In this example, the marker is over/under (i.e., whether the total combined points of the upcoming sporting event will exceed the over/under value estimated by an oddsmaker).

Referring back to FIG. 3, depicted is a method for automatically displaying a quantification of a divergence to a user in accordance with one embodiment of the present invention. This process may be used for calculation of over/under divergence as well as game/win loss divergence as discussed below.

Process 300 begins at 302, at which a user wishes to view a quantification of a divergence for over/under for an upcoming sporting event in which they are interested. In one exemplary Internet embodiment of the present invention, a user begins this process by accessing a web page on the Internet as discussed in greater detail above with respect to Example 1.

Next, at 304, server 220 provides the user's Web browser with a Web page depicting various upcoming sporting events for which the divergence of gaming markers may be quantified such as the Web page depicted in FIG. 4. This Web page allows a user to select various information regarding the divergence to be quantified via a plurality of pull-down menus as also discussed above in greater detail with respect to Example 1.

Next, process 300 proceeds to 306, at which the user has entered all selections in the available pull-down menus. The user then clicks on the chart-it link 410 to activate the system to generate a graph of over/under win/losses and to calculate a divergence value in accordance with the data entered by the user. It should be noted that: an over/under win occurs when the total points scored in the event exceeded the over/under value estimated by the oddsmaker for that event; an over/under loss occurs when the total points scored in the event falls below the over/under value estimated by the oddsmaker for that event; and an over/under push occurs when the total points scored in the event is equal to the over/under value estimated by the oddsmaker for that event.

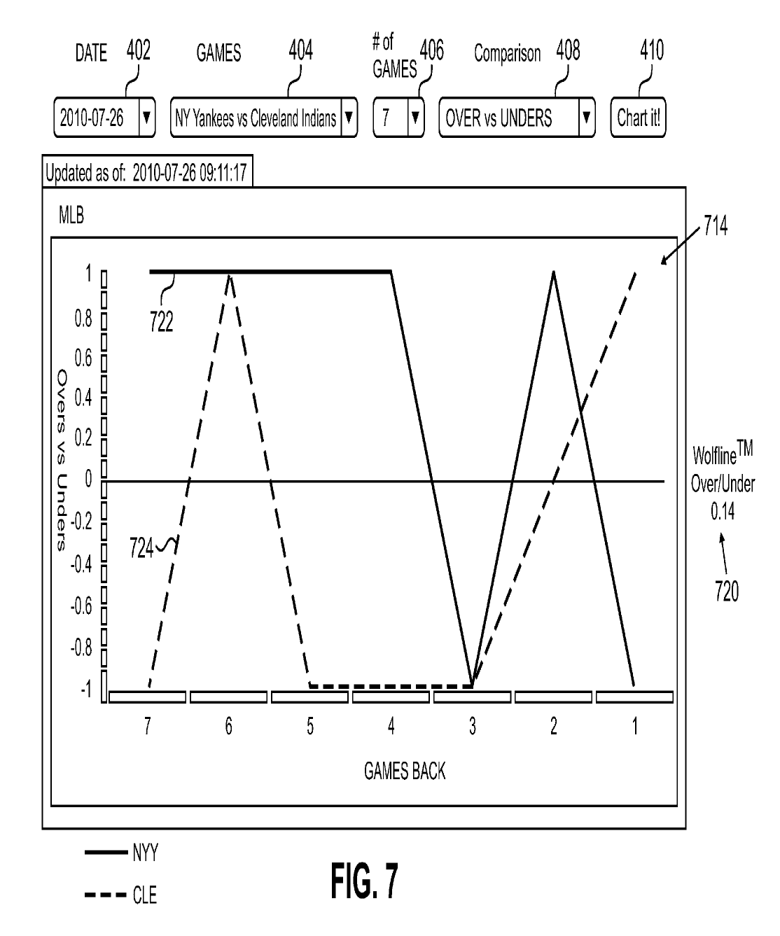

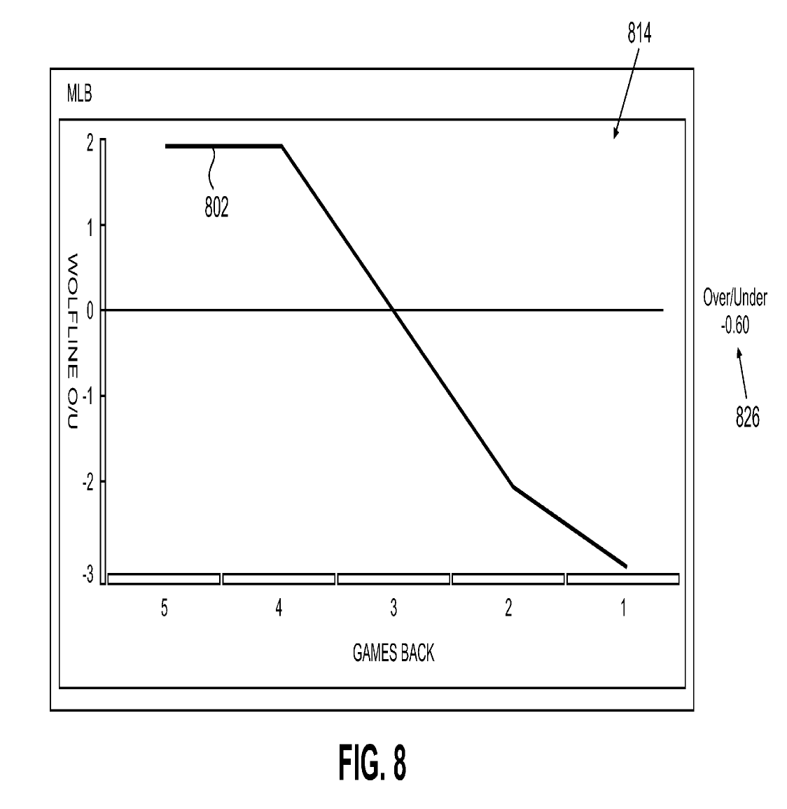

An exemplary Web page that may result for this example based upon the user's selections and the calculation of the steps discussed below is depicted in FIG. 7. In this figure, we see that the user has selected pull-down choices in order to quantify the divergence of an over/under gaming marker for the Jul. 26, 2010 baseball game between the New York Yankees and the Cleveland Indians. The user has also requested use of data for the last seven games played by both teams in the calculation of the divergence by selecting a number of 7 in pull-down menu 406. Selecting “Over vs Unders” in pull-down menu 408 notifies the system that the gaming marker selected by the user is over/under (i.e., whether the total number of points scored in the game will exceed the over/under value estimated by the oddsmaker) and the user wishes to see a graph of over/under win/loss data in which the actual over/under win or loss for each event is the data value. An alternate graph option that may also be selected via pull-down menu 408 is a “Cumulative Over/Under Win/Loss” option as discussed in greater detail below with respect to FIG. 8.

Next, at step 308, the database connection and authorization values are set to allow server 220 to establish a connection to database 224 to allow historical data for over/under for the last seven events (as selected by the user in step 304) for each of the two selected entities to be retrieved therefrom. This historical data is required to calculate the divergence of the upcoming event.

After the database connection and authorization values are set in step 308, process 300 proceeds to 314, at which a bi-directional database connection is established. This connection allows server 220 to communicate with database 224 to retrieve the required historical data. Process 300 then proceeds to 316.

At 316, process 300 will retrieve the data required to assign a value to the measured marker for each event in the selected cumulative time period of seven games back. Since the marker selected by the user is over/under, server 220 executes an over/under value query for each of the selected teams for each of the last seven games played. Once this data is retrieved, the process then proceeds to step 318.

At 318, a value is assigned to each event for each team for the last seven games played. In this embodiment, a value of +1 is applied for each event in which the total number of points scored in the event exceeded the over/under value estimated by the oddsmaker for that event. A value of −1 is applied for each event in which the total number of points scored in the event fell below the over/under value estimated by the oddsmaker for that event. A value of 0 is applied for each event in which the total number of points scored in the event equalled the over/under value estimated by the oddsmaker for that event. That is, a straight over/under win or loss value is associated with each event.

Various other embodiments for assigning values are envisioned. In one scenario, the value assigned to one or more events is the numerical difference between an actual outcome of an event and the estimated outcome of the event. For example, in the case of over/under, the actual number of points by which a team exceeded the over/under value or failed to meet the over/under value would be the assigned value. In another example involving a point spread, the actual number of points by which a team exceeded the point spread or failed to meet the point spread would be the assigned value.

In another embodiment, the value assigned to one or more events is the percentage difference between an actual outcome of an event and the estimated outcome of the event. For example, in the case of over/under, the percentage by which a team exceeded the over/under value or failed to meet the over/under value would be the assigned value. In another example involving a point spread, the percentage by which a team exceeded the point spread or failed to meet the point spread would be the assigned value. These examples are not meant to be limiting as the invention may assume many forms of assigned values.

Next, at 320, for each team, all of the values for each of the last seven games are summed to create a cumulative over/under win/loss value. At 322, the cumulative over/under values are compared and the lower cumulative over/under value is added to the higher cumulative over/under value to calculate a divergence spread.

Next, at 324, the divergence spread is divided by the DSN. In our example, the DSN equals 7. The result of this calculation is the divergence value.

After the divergence value has been calculated, process 300 proceeds to 326 at which the divergence value and/or one or more graphs are displayed to a user via a Web page such as that depicted in FIG. 7. Please note that the Web pages of FIGS. 4 and 7 are nearly identical with the exception that the Web page in FIG. 7 includes the over/under divergence number 720 and a graph 714 depicting the over/under performance of both teams in the last seven games. In this example, the chart in FIG. 7 shows the over/under win, loss, or push of each game in accordance with the values assigned to each win, loss, or push in step 318 as discussed above (i.e., each win is depicted as a +1, each loss is depicted as a −1, and each push is depicted as a 0).

In an alternate embodiment of graph 714 created for a user, the graph depicts cumulative over/under win/loss rather than per event over/under loss. Such a graph 814 is depicted in FIG. 8 and it may be substituted for graph 714, or provided in addition to graph 714. In one embodiment of the present invention, a user simply selects a “Cumulative Over/Under” option from pull-down menu 408.

As seen in FIG. 8, the over/under win/loss line for each event and for both teams is cumulative. For example, when reviewing data line 802, which is a combined data line for both the New York Yankees (“NYY”) and the Cleveland Indians (“CLE”), graph 814 indicates that both events played by NYY and CLE five games back had total points that exceeded the over/under value estimated by the oddsmaker for each event. That is, the data value at five games back is +2 because NYY beat the over/under in its 5^{th} game back (resulting in assignment of a value of +1) and CLE beat the over/under in its 5^{th} game back (resulting in assignment of a value of +1), therefore, the data value is the sum of these two events, or +2.

At four games back, graph 814 has a data value of +2. The change from the previous data value is zero (i.e., +2 remains +2 from five games back to four games back). This indicates that either both NYY and CLE pushed (0 summed with 0 equals zero) or that one team beat the over/under and one team lost the over/under (+1 summed with −1 equals zero).

Similarly, the data values of 0 at three games back and −2 at two games back indicate that both teams failed to beat the over/under (−1 summed with −1 equals −2). At one game back, the data value is −3, which is a decrease of one as compared to the data value at two games back. This change indicates that one team lost and one team pushed (−1 summed with 0 equals −1).

A cumulative over/under graph may be preferred by a user of the method. This graph makes it easier for a user to view the performance of both teams as one cumulative graph. Data line 802 depicts the overall trend of both teams' scoring abilities. Very high and very low levels for the cumulative over/under data line show very hot or very cold teams, respectively. That is, hot teams have historically scored a higher quantity of points which drives up the perception that the teams will continue to stay hot. Similarly, cold teams have historically scored a low quantity of points which drives up the perception that the teams will continue to stay cold.

Also, when calculating divergence, the cumulative over/under graph eliminates the need to sum the values assigned to each event since the graph performs this function. Each sum for all events in the cumulative time period is simply equal to the value of one game back (as presented on the cumulative over/under graph). As depicted in FIG. 8, the over under divergence is −0.60. This value may be calculated by dividing the data point at one game back (i.e., −3) by the DSN of 5 (in this example, the user has selected to see divergence data based upon the historical data for five games back)

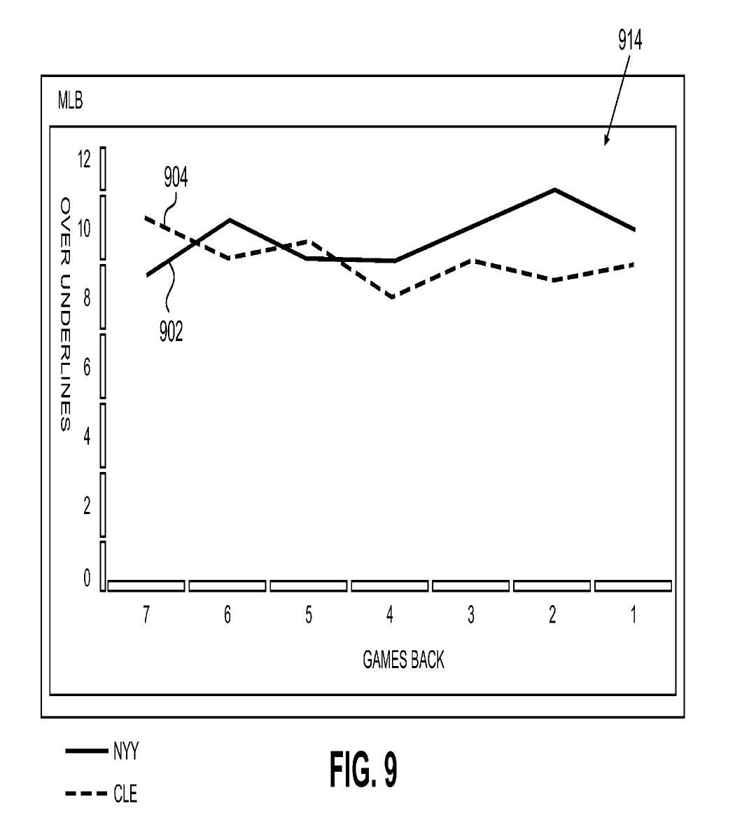

In yet another alternate embodiment of graph 714 created for a user, the graph depicts actual over/under values in accordance with an alternate embodiment of the present invention. Such a graph 914 is depicted in FIG. 9 and it may be substituted for graph 714, or provided in addition to graph 714. In one embodiment of the present invention, a user simply selects an “Actual Over/Under Values” option from pull-down menu 408 as discussed in greater detail above.

As seen in FIG. 9, the actual over/under line of graph 914 includes data that indicates the actual number of points by which each team beat the over/under estimate for a particular game. For example, data line 902 represents historical over/under data for NYY. At seven games back through one game back, data line 902 indicates that NYY beat its over/under by 8, 10, 9, 9, 10, 11, and 10 points, respectively. Data line 904 represents historical over/under data for CLE. At seven games back through one game back, data line 904 indicates that CLE beat its over/under by 10, 9, 10, 8, 9, 8, and 9 points, respectively.

Referring back to FIG. 7, the calculated over/under divergence 720 is 0.14. This value is derived as discussed above by summing each of the values assigned to the over/under of each event for each team. Therefore, the sum of the over/under values assigned for NYY equals the sum of +1, +1, +1, +1, −1, 0, and +1 (i.e., the assigned values for seven games back through one game back, respectively) for a total of +4. The sum of the over/under assigned values for CLE equals the sum of −1, +1, −1, −1, −1, +1, and −1 (i.e., the assigned values for seven games back through one game back, respectively) for a total of −3. The divergence spread is calculated by adding these two sums together (+4 +−3) for a total of 1. The divergence spread of 1 is divided by the DSN of 7 (as selected by the user) to equal a divergence of 0.1428, which is rounded down to 0.14.

Finally, at step 328, the calculated divergence may be compared to a scale for such divergence to determine whether the calculated divergence is statistically significant. The scale of Table 1 above may be used for determining the significance of the divergence value. In addition, negative over/under divergence values may be categorized according to the following Table 2:

TABLE 2

| Range | Significance | Color Coding |
|---|---|---|
| −0.79 to 0 | Not Significant | No Color |
| −0.8 to −1.19 | Significant | Yellow |
| −1.20 to −1.59 | Very Significant | Orange |
| −1.60 to −2.00 | Extremely Significant | Red |

The higher the statistical significance of the calculated divergence of the measured marker, the higher the likelihood that Means Reversion will cause an entity to fail to achieve an expected marker. In our example, the divergence value of 0.14 rates a Not Significant in the scale of Table 1. Therefore, it is not likely that Means Reversion will cause an unexpected result in the upcoming competition between NYY and CLE. Additionally, a significant divergence value may be programmed to alert a user as discussed in greater detail above with respect to Example 1.

### EXAMPLE 3

Similar to Example 1, Example 3 is also an application of the systems and methods of the present invention to sporting event competitions for various markers. In this example, the marker is against the spread (“ATS”)(i.e., a team beats the spread if it beats the opposing team by a greater number of points than the spread estimated by the oddsmaker).

Referring back to FIG. 3, depicted is a method for automatically displaying a quantification of a divergence to a user in accordance with one embodiment of the present invention. This process may be used for calculation of ATS divergence as well as game/win loss divergence as discussed below.

Process 300 begins at 302, at which a user wishes to view a quantification of a divergence for ATS for an upcoming sporting event in which he or she is interested. In one exemplary Internet embodiment of the present invention, a user begins this process by accessing a web page on the Internet as discussed in greater detail above with respect to Example 1.

Next, at 304, server 220 provides the user's Web browser with a Web page depicting various upcoming sporting events for which the divergence of gaming markers may be quantified such as the Web page depicted in FIG. 4. This Web page allows a user to select various information regarding the divergence to be quantified via a plurality of pull-down menus as also discussed above in greater detail with respect to Example 1.

Next, process 300 proceeds to 306, at which the user has entered all selections in the available pull-down menus. For this example, the user will select an option such as “Against the Spead” in pull-down menu 408. The user then clicks on the chart-it link 410 to activate the system to generate a graph of ATS win/losses/pushes and to calculate a divergence value in accordance with the data entered by the user. It should be noted that: an ATS win occurs when the winning team beats the losing team by a greater number of points than the spread estimated by the oddsmaker for that event (i.e., the team beats the spread); an ATS loss occurs when the winning team does not beat the losing team by a greater or equal number of points than the spread estimated by the oddsmaker for that event (i.e., the team does not beat the spread); and an ATS push occurs when when the winning team beats the losing team by a number of points equal to the spread estimated by the oddsmaker for that event (i.e., a push).

Next, at step 308, the database connection and authorization values are set to allow server 220 to establish a connection to database 224 to allow historical data for ATS for the last quantity of events (as selected by the user in step 304) for each of the two selected entities to be retrieved therefrom. This historical data is required to calculate the divergence of the upcoming event.

After the database connection and authorization values are set in step 308, process 300 proceeds to 314, at which a bi-directional database connection is established. This connection allows server 220 to communicate with database 224 to retrieve the required historical data. Process 300 then proceeds to 316.

At 316, process 300 will retrieve the data required to assign a value to the measured marker for each event in the selected cumulative time period. Since the marker selected by the user is ATS, server 220 executes an ATS value query for each of the selected teams for each of the games in the cumulative time period. Once this data is retrieved, the process then proceeds to step 318.

At 318, a value is assigned to each event for each team for all events in the cumulative time period. In this embodiment, a value of +1 is applied for each event in which the team beats the spread. A value of −1 is applied for each event in which the team doesn't beat the spread. A value of 0 is applied for each event in which there is a push.

Next, at 320, for each team, all of the values for each of the games in the cumulative time period are summed to create a cumulative ATS value. At 322, the cumulative ATS values are compared and the lower cumulative ATS value is subtracted from the higher cumulative ATS value to calculate a divergence spread.

Next, at 324, the divergence spread is divided by the DSN. The result of this calculation is the divergence value.

After the divergence value has been calculated, process 300 proceeds to 326 at which it is displayed to a user, for example, via a Web page with or without a graph of ATS values similar to the graphs discussed above in Examples 1 and 2.

Finally, at step 328, the calculated divergence may be compared to a scale for such divergence to determine whether the calculated divergence is statistically significant such as the scale depicted in Table 1 above.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method to evaluate defined markers comprising the steps of:
defining at least two entities;
defining a measured marker;
defining a cumulative period of events of the two entities, each event having the measured marker;
assigning a value to the measured marker based on the at least two entities achievement or failure to obtain the measured marker for each event during the cumulative period;
measuring the divergence of the value of the measured marker during the cumulative period; and
quantifying the divergence.

2. The method of claim 1, wherein the value assigned to the measured marker is at least one of the group consisting of an integer, an actual value, and a percentage.

3. The method of claim 1, wherein a sum of the values assigned to the measured markers defines a divergence spread.

4. The method of claim 3, wherein the divergence is quantified by dividing the divergence spread by a quantity of events occurring during the cumulative period.

5. The method of claim 1 further comprising:
weighting the value assigned to the measured marker of one or more of the events occurring during the cumulative period.

6. The method of claim 5, wherein the weighting is based upon a chronological order of an occurrence of the event during the cumulative period.

7. The method of claim 1 further comprising the step of:
implementing a scale to evaluate a strength of the quantified divergence.

8. The method of claim 1 further comprising the step of:
alerting a user of the method of the strength of the quantified divergence.

9. A system employed in connection with providing data to quantify mispricing of a gaming marker to a user, the system for providing the data in an electronic form to a requestor, the system comprising:
an interface that allows the requestor to enter information to obtain the data quantifying mispricing of the gaming marker for at least one upcoming event, the information defining at least two entities, a measured marker; and a cumulative period of events of the two entities, each event having the measured marker;
a database that receives historical data of historical events;
a processing unit to receive the information input by the requestor and perform at least one of the group consisting of calculating a divergence of the at least one upcoming event based upon said information received from the requestor and said historical data; creating at least one graph of historical data, and combinations thereof, the calculating of the divergence including assigning a value to the measured marker based on the at least two entities achievement or failure to obtain the measured marker during the cumulative period; and
a display unit to display at least one of the group consisting of the divergence of the at least one upcoming event, the at least one graph, and combinations thereof to the requestor.
